(19) United States
(12) Patent Application Publication
(10) Pub. No.: US 2005/0165434 A1
(43) Pub. Date: Jul. 28, 2005

(54) Surgical instrument for single entry portal

(75) Inventors: Gabriel Nierenberg, Haifa (IL); Pietro D'Agostino, Haifa (IL)

Correspondence Address: FRISHAUF, HOLTZ, GOODMAN & CHICK, PC, 220 5TH AVE. FL 18, NEW YORK, NY, 10001-7708, US

(73) Assignee: BRETON GROUP LTD., Haifa (IL)

(21) Appl. No.: 11/041,023

(22) Filed: Jan. 21, 2005

Related U.S. Application Data
(60) Provisional application No. 60/538,462, filed on Jan. 26, 2004.

(51) Int. Cl. G05D 23/32

(52) U.S. Cl. 606/167

(57) ABSTRACT

A method and an apparatus for gaining access into a cavity interior disposed inside a human body for simultaneous and selective operation of medical implements and fluids, having at least one main duct and an auxiliary duct. The auxiliary duct has an auxiliary proximal section, and an auxiliary distal section coupled to the main duct, and an auxiliary medial section that is pivotable about the main duct. The auxiliary duct is introduced in the cavity interior when in a first closed mode wherein all the auxiliary sections are aligned. When partially inside the cavity interior, the auxiliary medial section is pivoted about the main duct into a second open mode, out of alignment with the auxiliary proximal section and the auxiliary distal section, whereby the auxiliary duct provides access to the cavity interior via two cannulae, in addition to the access provided by the at least one main duct.

The present application is related to Provisional Application Ser. No. 60/538,462 filed on Jan. 26, 2004, the priority date of which is claimed herein, and the contents of which is incorporated herein in whole by reference.

### BACKGROUND OF THE INVENTION

1. Field of the Invention

The present invention relates generally to medical devices used to provide access into the human body. More particularly, the present invention is directed to access devices that provide a single, relatively long-term, entry portal into the body. The entry portal is used by doctors and other medical professionals to selectively introduce a variety of medical implements and fluids into the body and for in vivo diagnostic testing and other treatment protocols.

2. Definitions

A cannula is a small tube for insertion into a body cavity with use of, or without the use of a trocar.

A lumen is the bore of a tube.

3. Description of Related Art

New medical treatments and diagnostic procedures are continually being developed, which require increasingly versatile access to the interior of the body. For example, organ transplant procedures and cardiac angioplasty require the introduction of complex combinations of medical implements and fluids into the body. Many of the presently available access devices could be better suited than they are to better accomplish these relatively complex procedures. As a result, a surgical intervention may require multiple access devices, which must be located at multiple access sites necessitating multiple entry punctures or incisions. Accordingly, there is a continuing need to provide improved access devices that have additional capabilities, which increase their versatility and usefulness for the increasing variety of invasive treatments and procedures.

The efforts to increase the number of implements for insertion into the human body through a single entry portal are lasting for years. For example, in U.S. Pat. No. 6,348,034, Thompson divulges a cannula divided longitudinally into a camera chamber and an instrument passage. Furthermore, U.S. Pat. No. 6,436,117 to Waller et al. discloses an instrument with a continuous hollow channel provided in the instrument, into which at least one additional instrument may be inserted. Moreover, in U.S. Pat. No. 6,827,710, Mooney et al. reveal an improved access device which is designed to provide selective introduction of medical implements into the body while simultaneously providing auxiliary access through dedicated multiple lumens. However, the multiple lumins are all defined within the same outer tube.

The problem of inserting one more cannula with a lumen for medical implements, without opening an additional entry portal has thus not yet been solved.

### BRIEF SUMMARY OF THE INVENTION

It is an object of the present invention to provide a method and an apparatus for inserting one more cannula with a lumen configured to receive medical implements, without opening an additional entry portal for providing access to a cavity interior in the human body. The importance of limiting the surgical intervention to one single portal relates to the endeavor to reduce operating time and the potential risk of infection, as well as to accelerate patient recovery.

It is a main object of the present invention to permit pivoting of a portion of a cannula already inserted in a cavity interior, to open up and provide one more cannula, whereby an additional lumen is made available through the same single entry portal incision.

It is an object of the present invention to provide a method and an apparatus for ganging access into a cavity interior disposed inside a human body for simultaneous and selective operation of medical implements and fluids by using at least one main longitudinal unitary tubular duct having a main proximal section, a main medial section, and a main distal section, and one auxiliary tubular duct disposed in parallel adjacent alignment to the at least one main duct, both the at least one main duct and the auxiliary duct providing access to the cavity interior. This includes the steps of separating the auxiliary duct into an auxiliary proximal section, an auxiliary medial section, and an auxiliary distal section, and coupling the auxiliary proximal section and the auxiliary distal section in fixed retention to, respectively, the main proximal section and the main distal section. There is also need of configuring the auxiliary medial section for pivotal rotation about the at least one main duct, from a first closed mode when in alignment with both the auxiliary proximal section and the auxiliary distal section, to a second open mode when pivoted away and out of alignment with both the auxiliary proximal section and the auxiliary distal section, and for providing two separate cannulae in the second open mode, wherein the main proximal section is one cannula, and the auxiliary proximal section is the second cannula using the auxiliary distal section as a guide. It is thus possible to provide access to the cavity interior via a single entry portal in both the first closed mode and the second open mode.

It is another object of the present invention to provide means for the introduction of, in the first closed mode, the main proximal section and the auxiliary proximal section into the cavity interior, and a portion of the main distal section and a portion of the auxiliary distal section into the cavity interior. In the second open mode these means include pivoting the auxiliary distal section to the open mode. This procedure thus includes the steps of inserting a portion of the at least one main duct and of the auxiliary duct into the cavity interior when in the closed mode, operating in the cavity interior in either one of both the closed mode and the open mode, and retrieving the at least one main duct and the auxiliary duct out of the cavity interior in the closed mode after operation completion.

It is yet another object of the present invention to provide means wherein the auxiliary medial section is pivotable about the at least one main duct in both clockwise and anti-clockwise directions of rotation. Moreover, at least one auxiliary section it disposed for pivotal rotation about the at least one main duct, and at least one other auxiliary section is rigidly fixed in parallel alignment to the at least one main duct.

It is noted that the at least one main duct and the auxiliary duct are made from materials selected alone and in combination from the group of materials consisting of metal and plastic materials.

It is still another object of the present invention to provide means wherein the auxiliary duct is coupled in operative association with one main duct out of the plurality of ducts, and wherein the auxiliary medial section is manually pivotable before and after insertion into the cavity interior. Furthermore, the auxiliary medial section is opened by pivoting in one direction when in the cavity interior, and is closed before retrieval out of the cavity interior by rotation in the same or in the opposite direction.

It is a further object of the present invention to provide a method and an apparatus for gaining access into a cavity interior disposed inside a human body for simultaneous and selective operation of medical implements and fluids by using at least one main longitudinal unitary tubular duct having a main proximal, a main medial, and a main distal section, and one auxiliary tubular duct disposed in parallel alignment to the at least one main duct, both the main and the auxiliary ducts providing access to the cavity interior. This calls for the auxiliary duct being separated into an auxiliary proximal section, and an auxiliary medial section, the auxiliary proximal section being coupled in fixed retention to the main proximal section, and the auxiliary medial section being configured for pivotal rotation about the at least one main duct, from a first closed mode when in alignment with the auxiliary distal section, to a second open mode when pivoted away and out of alignment with the auxiliary proximal section. Thus, the second open mode provides two separate cannulae, wherein the main proximal section is one cannula and the auxiliary proximal section is the second cannula, whereby access into the cavity interior is gained via at least the main proximal section and the auxiliary proximal section when in the first closed mode, and through at least the main proximal section, the auxiliary proximal section, and the auxiliary medial section when in the second open mode.

### BRIEF DESCRIPTION OF THE DRAWINGS

In order to understand the invention and to see how it may be carried out in practice, preferred embodiments will now be described, by way of non-limiting example only, with reference to the accompanying drawings, in which similar reference numerals and characters refer to similar elements in the various Figs.:

FIG. 1 is a side elevation of a first embodiment 100 of a unitary surgical instrument when in the closed mode,

FIG. 2 is a side elevation of the first embodiment 100 when in the open mode,

FIG. 3 illustrates a cross-sectional view taken in the A-A plane of FIG. 2, and

FIG. 4 depicts a second embodiment 200 of the unitary surgical instrument.

### DETAILED DESCRIPTION OF THE INVENTION

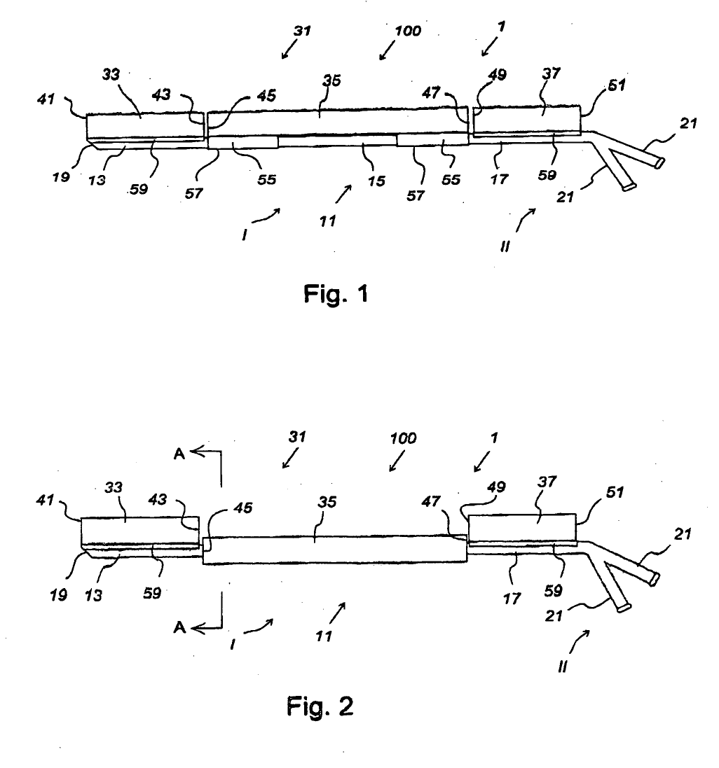

FIG. 1 shows an exemplary embodiment 100 of a unitary surgical instrument 1, for simultaneous access with multiple medical implements and with fluids used in surgery, via one entry portal, into a cavity interior in the human body. The entry portal, the interior cavity, the human body, medical implements and devices are not shown in the Figs. for the sake of clarity.

The unitary surgical instrument 1 has a main hollow tubular duct 11 having a main proximal portion I and a main distal portion II, and an auxiliary duct 31.

For the sake of orientation, proximal refers to the direction or the side close to the entry portal, and distal points to the opposite side or direction.

In FIG. 1 the length of the proximal portion I of the main duct 11 is divided only for the ease of description, into a main proximal section 13, a main medial section 15, and a main distal section 17. Preferably, the open main free end extremity 19 of the main proximal section 13 is cut off obliquely to facilitate introduction into an incision, or entry portal, opened in the human body.

The distal portion 11, disposed in continuation of the proximal portion I of the main duct 11, possibly terminates in one, two, or more diverging branches 21. For example, FIG. 1 shows two branches 21, each branch being configured for operative association with further medical implements such as instruments and fluids passing therethrough. The main duct 11 may include a single or a plurality of parallel cannulae with a single lumen or divided into a plurality of lumina, as known in the art. The main duct 11 may accommodate the passage of fluids into and out of the cavity interior, as well as the simultaneous or sequential passage therethrough of one or more surgical implements, such as a camera, optical fibers, stretching, refractors, forceps, and other instruments.

In embodiment 100, the auxiliary tubular duct 31 is physically divided, for example, into three separate longitudinally aligned open-ended auxiliary sections, as shown in FIG. 1. The three auxiliary sections are an auxiliary proximal section 33, an auxiliary medial section 35, and an auxiliary distal section 37. The auxiliary proximal section 33 has an auxiliary proximal free end 41 and a distal end 43. Likewise, the auxiliary medial section 35 has a proximal end 45 and a distal end 47, while the auxiliary distal section 37 has an auxiliary proximal end 49 and an auxiliary distal free end 51. Although not shown in FIG. 1, if desired, the proximal end 45 of the auxiliary medial section 35 is cut off obliquely to facilitate introduction into an incision or entry portal opened in the human body.

The auxiliary proximal and auxiliary distal sections, respectively 33 and 35, are coupled in parallel longitudinal fixed retention to respectively, the main proximal section 13 and the main distal section 17, while the auxiliary medial section 35, which is disposed intermediate the auxiliary proximal and auxiliary distal sections, is coupled in reversible pivotal rotation about the main duct 11.

As shown in FIGS. 1, 2, and 3, a bushing 55 that is journaled on the exterior of the main duct 11, having ambushing exterior 57 that is fixedly retained in coaxial alignment with the auxiliary medial section 35, suffices to permit pivotal rotation of the auxiliary medial section about the main duct 11. The Figs. show two bushings 55 journaled on the exterior of the main duct 11. A first bushing 55 is disposed adjacent the open proximal end 45 of the auxiliary medial section 35 and a second bushing 55 adjacent the open distal end 47 of the auxiliary medial section 35. Both bushings 55 are fixedly coupled to the auxiliary medial section 35. Other means for providing pivotal rotation, such as only one bushing 55, or more bushings 55, or hinge means of any kind well known to the art, are also feasible.

FIG. 2 shows the auxiliary medial section 35 pivoted at 90° to the side for example, even though the auxiliary medial section 35 is disposed in free manual pivotal rotation about the main duct 11, to any desired angle, in both clockwise and anti-clockwise directions of rotation.

A connection piece 59 is disposed intermediate both the auxiliary proximal section 33 and the auxiliary medial section 35, and the main duct 11, in compensation of the thickness of the busing(s) 55, to ensure longitudinal coaxial alignment of all the sections of the auxiliary duct 31.

The auxiliary medial section 35 is thus pivotable from a first closed mode when in alignment with both the auxiliary proximal and the auxiliary distal sections, respectively 33 and 37, to a second open mode when pivoted away and out of alignment with both last same auxiliary proximal and distal sections.

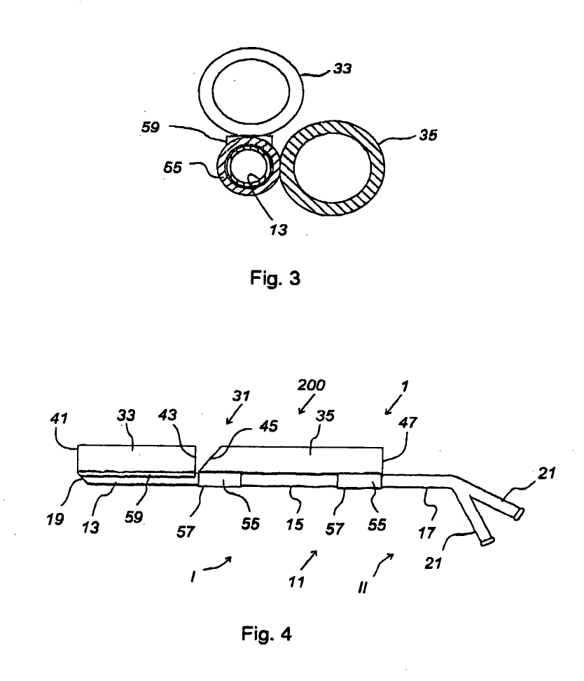

FIG. 3 depicts a cross section Cut along a plane A-A shown in FIG. 2, in perpendicular to tho bushing 55, with the auxiliary medial section 35 in the second open mode, and in pivotal rotation of 90° out of the vertical, opened to one side.

As described hereinabove, it is possible to pivot, or to swivel the auxiliary medial section 35 in both clockwise and anti-clockwise directions of rotation, to any practical desired angle. The fixed retention and pivotal rotation of the respective sections of the auxiliary duct 31 to the main duct 11 is possibly realized differently, as known to the art, in configurations using means other than the connection piece 59 and the bushing 55 disposition shown in the Figs.

Although the interior of the main duct 11 is shown in FIG. 3 as providing one single lumen, subdivision into a plurality of lumina is well known to the art.

In the first closed mode, all the auxiliary sections, respectively 33, 35, and 37, are disposed in co-extensive longitudinal alignment and provide one auxiliary tubular duct 31 for medical implements and for fluids. However, in the second open mode, after pivoting, a primary cannula and a separate secondary cannula are formed, each cannula for the insertion via the same single entry portal, of separate medical instruments or other means. In the second open mode, the auxiliary duct 31 thus opens up to create one more cannula over the number of cannulae that was introduced into the cavity interior in the first closed mode.

It is noted that the unitary surgical instrument 1 may be made out of metal or out of plastic material, either in part or in combination of both.

In operation, a single entry portal is cut open for gaining access to an interior cavity of the human body. Then, in the first the closed mode, the main proximal section and the auxiliary proximal section of the unitary surgical instrument 1, respectively 13 and 33, are introduced in the entry portal, preferably with a trocar, or obturator, not shown in the Figs., which is inserted in the interior of the lumen formed by the auxiliary tubular duct 31. For example, an obturator of appropriate length and outside diameter to match the lumina of the auxiliary duct 31 is introduced into the auxiliary distal section 37, to emerge from the auxiliary proximal section 33. The obturator thus passes, in sequence, via the distal end 51 and proximal end 49 of the auxiliary distal section 37, the distal end 43 and proximal end 45 of the auxiliary medial section 35, and the distal end 43 and proximal end 41 of the auxiliary proximal section 33. Should the obturator be retrieved in the first closed mode, then only the lumina provided by the main duct 11 and the auxiliary duct 31 would be available for surgical purposes.

To provide for one more cannula, the unitary surgical instrument I is inserted deeper into the cavity interior until at least a proximal portion of the main medial section and of the auxiliary medial sections, respectively 15 and 35 are introduced past the entry portal an into the cavity interior. It is at this stage, namely in the first closed mode, that the obturator should be retrieved out of the auxiliary duct 31.

The next step calls for the manual pivoting of the auxiliary medial section 35 to an appropriate angle to create one additional cannula for access into the cavity interior, still through the same single entry portal. The main duct 11 remains available for use as in the previous closed mode, but the auxiliary tubular duct 31 has now opened to provide two cannulae, each cannula with one lumen permitting the insertion of one surgical instrument therethrough. A first surgical instrument is introduced via the lumen of the auxiliary distal section 37 acting as a guide, and lo then through and out of the lumen of the auxiliary proximal section 33 residing in the cavity interior. A second surgical instrument is introduced via the lumen of the auxiliary medial section 35, at least one proximal portion 45 of which resides in the cavity interior.

Thereby, the auxiliary duct 31 now offers not one but two lumina for surgical purposes. In other words, one more lumen is made available for a single entry portal. Many typical surgical interventions made with conventional surgical equipment require up to three or four entry portals, but the application of the unitary surgical instrument 1 may reduce the number of entry portals necessary to be opened in the human body.

In principle, it is sufficient to provide the auxiliary duct 31 with only two separate sections to obtain results similar to those described hereinabove.

FIG. 4 shows an embodiment 200 where the auxiliary duct 31 has only but a proximal auxiliary proximal section 33 and an auxiliary medial section 35. One may thus consider the embodiment 200 as if being the embodiment 100 but without the auxiliary distal section 37. If desired, the auxiliary proximal end 45 of the auxiliary medial section 35 is shaved off in oblique to facilitate penetration via the entry portal

In the embodiment 200, when the auxiliary medial section 35 is pivoted about the main duct 11 in the same manner as described hereinabove, while the auxiliary tubular duct 31 is coupled to the main duct 11, then again the auxiliary tubular duct 31 is openable from a first closed mode to a second open mode, to provide one more cannula.

Operation of the embodiment 200 requires first, the introduction of the unitary surgical instrument 1 until at least a proximal portion 45 of the auxiliary medial section 35 is disposed in the cavity interior. It is understood that use is made of a trocar inserted through the whole length of the auxiliary duct 31 and extending thereout out of the auxiliary proximal free end 41.

Second, the trocar is retrieved out of the auxiliary duct 32, and the auxiliary media section 35 is manually pivoted out of alignment with the auxiliary proximal section 33. This permits to introduce a first medical implement through the auxiliary proximal section 33 until it exits not only just out of the auxiliary proximal end 45, but about as deep as the auxiliary proximal free end 41.

Third, the unitary surgical instrument 1 is slightly retrieved out of the entry port in sliding motion of the auxiliary proximal section 33 relative to the first medical implement, which is kept in firm retention in the cavity's interior. Retrieval of the unitary surgical instrument 1 continues until a distal portion of the auxiliary proximal section 33, or even only the auxiliary distal end 43 of the auxiliary proximal section 33 emerges out of the entry portal, thus providing one more cannula.

Fourth, a second medical implement is introduced through the auxiliary proximal section 33 and into the cavity interior. At this stage, both the auxiliary proximal section 33 and the auxiliary medial section 35 provide each a cannula for the first and for the second medical implement, whereby it becomes possible to insert one more device into the cavity interior through the same single entry portal.

It will be appreciated by persons skilled in the art, that the present invention is not limited to what has been particularly shown and described hereinabove. For example, if desired, the auxiliary pivotally rotating medial section may be locked in a selected angular disposition relative to the at least one main duct. Furthermore, to firmly but reliably retain a medical instrument in place when inserted in the auxiliary distal section 37 or in the auxiliary medial section 39, it is possible to add a suitable implement to that end. Examples are a setscrew, a releasable one-way devices or a spring-loaded or friction activated mechanism. Moreover, one may consider an auxiliary duct 31 providing more than one single lumen. Rather, the scope of the present invention is defined by the appended claims and includes both combinations and subcombinations of the various features described hereinabove as well as variations and modifications thereof which would occur to persons skilled in the art upon reading the foregoing description.

1. A method for gaining access into a cavity interior disposed inside a human body for simultaneous and selective operation of medical implements and fluids by using at least one main longitudinal unitary tubular duct having a main proximal section, a main medial section, and a main distal section, and one auxiliary tubular duct disposed in parallel adjacent alignment to the at least one main duct, both the at least one main duct and the auxiliary duct providing access to the cavity interior, the method comprising the steps of:
separating the auxiliary duct into an auxiliary proximal section, an auxiliary medial section, and an auxiliary distal section,
coupling the auxiliary proximal section and the auxiliary distal section in fixed retention to, respectively, the main proximal section and the main distal section,
configuring the auxiliary medial section for pivotal rotation about the at least one main duct, from a first closed mode when in alignment with both the auxiliary proximal section and the auxiliary distal section, to a second open mode when pivoted away and out of alignment with both the auxiliary proximal section and the auxiliary distal section, and
providing two separate cannulae in the second open mode, wherein the main proximal section is one cannula, and the auxiliary proximal section is the second cannula using the auxiliary distal section as a guide.
whereby access into the cavity interior is gained via at least the main proximal section and the auxiliary proximal section when in the first closed mode, and through at least the main proximal section, the auxiliary proximal section, and the auxiliary medial section when in the second open mode.

2. The method according to claim 1, wherein:
access to the cavity interior is provided via a single entry portal in both the first closed mode and the second open mode.

3. The method according to claim 1, further comprising the steps of:
in the first closed mode:
introducing the main proximal section and the auxiliary proximal section into the cavity interior,
introducing a portion of the main distal section and a portion of the auxiliary distal section into the cavity interior, and
in the second open mode:
pivoting the auxiliary distal section to the open mode.

4. The method according to claim 1, further comprising the steps of:
inserting a portion of the at least one main duct and of the auxiliary duct into the cavity interior when in the closed mode,
operating in the cavity interior in either one of both the closed mode and the open mode, and
retrieving the at least one main duct and the auxiliary duct out of the cavity interior in the closed mode after operation completion.

5. The method according to claim 1, wherein:
the auxiliary medial section is pivotable about the at least one main duct in both clockwise and anti-clockwise directions of rotation.

6. The method according to claim 1, wherein:
the at least one main duct and the auxiliary duct are made from materials selected alone and in combination from the group of materials consisting of metal and plastic materials.

7. The method according to claim 1, wherein:
at least one auxiliary section is disposed for pivotal rotation about the at least one main duct, and
at least one other auxiliary section is rigidly fixed in parallel alignment to the at least one main duct.

8. The method according to claim 1, wherein:
the at least one main duct comprises a plurality of ducts, and
the auxiliary duct is coupled in operative association with one main duct out of the plurality of ducts.

9. The method according to claim 1, wherein:
the auxiliary medial section is manually pivotable before and after insertion into the cavity interior.

10. The method according to claim 1, wherein:
the auxiliary medial section is opened by pivoting in one direction when in the cavity interior, and is closed before retrieval out of the cavity interior by rotation in the slime or the opposite direction.

11. An apparatus for gaining access into a cavity interior disposed inside a human body for simultaneous and selective operation of medical implements and fluids by using at least one main longitudinal unitary tubular duct having a main proximal, a main medial, and a main distal section, and one auxiliary tubular duct disposed in parallel alignment to the at least one main duct, both the main and the auxiliary ducts providing access to the cavity interior, comprising:
the auxiliary duct being separated into an auxiliary proximal section, an auxiliary medial section, and an auxiliary distal section,
the auxiliary proximal section and the auxiliary distal section being coupled in fixed retention to, respectively, the main proximal section and the main distal section,
the auxiliary medial section being configured for pivotal rotation about the at least one main duct, from a first closed mode when in alignment with both the auxiliary proximal section and the auxiliary distal section, to a second open mode when pivoted away and out of alignment with both the auxiliary proximal section and the auxiliary distal section, and
the second open mode providing two separate cannulae, wherein the main proximal section is one cannula, and the auxiliary proximal section is the second cannula using the auxiliary distal section as a guide,
whereby access into the cavity interior is gained via at least the main proximal section and the auxiliary proximal section when in the first closed mode, and through at least the main proximal section, the auxiliary proximal section, and the auxiliary medial section when in the second open mode.

12. The apparatus according to claim 1, wherein:
a single entry portal provides access to the cavity interior in both the first closed mode and the second open mode.

13. The apparatus according to claim 1, wherein:
in the first closed mode:
the main proximal section and the auxiliary proximal section are first introduced into the cavity interior,
a portion of the main distal section and a portion of the auxiliary distal section are introduced next into the cavity interior, and
in the second open mode:
the auxiliary distal section is then pivoted to the open mode.

14. The apparatus according to claim 1, wherein:
a portion of the at least one main duct and of the auxiliary duct is inserted into the cavity interior when in the closed mode,
operation in the cavity interior is performed in either one of both the closed mode and the open mode, and
the at least one main duct and the auxiliary duct are retrieved out of the cavity interior in the closed mode after operation completion.

15. The apparatus according to claim 1, wherein:
the auxiliary medial section is pivotable about the at least one main duct in both clockwise and anti-clockwise directions of rotation.

16. The apparatus according to claim 1, wherein:
the at least one main duct and the auxiliary duct are made from materials selected alone and in combination from the group of materials consisting of metal and plastic materials.

17. The apparatus according to claim 1, wherein:
at least one auxiliary section is disposed for pivotal rotation about the at least one main duct, and
at least one other auxiliary section is rigidly fixed in parallel alignment to the at least one main duct.

18. The apparatus according to claim 1, wherein:
the at least one main duct comprises a plurality of ducts, and
the auxiliary duct is coupled in operative association with one main duct out of the plurality of ducts.

19. The apparatus according to claim 1, wherein:
the auxiliary medial section is opened by pivoting in one direction when in the cavity interior, and is closed before retrieval out of the cavity interior by rotation in the same or in the opposite direction.

20. An apparatus for gaining access into a cavity interior disposed inside a human body for simultaneous and selective operation of medical implements and fluids by using at least one main longitudinal unitary tubular duct having a main proximal, a main medial, and a main distal section, and one auxiliary tubular duct disposed in parallel alignment to the at least one main duct, both the main and the auxiliary ducts providing access to the cavity interior, comprising:
the auxiliary duct being separated into an auxiliary proximal section, and an auxiliary medial section,
the auxiliary proximal section being coupled in fixed retention to the main proximal section,
the auxiliary medial section being configured for pivotal rotation about the at least one main duct, from a first closed mode when in alignment with the auxiliary distal section, to a second open mode when pivoted away and out of alignment
with the auxiliary proximal section, and
the second open mode providing two separate cannulae, wherein the main proximal section is one cannula, and the auxiliary proximal section is the second cannula,
whereby access into the cavity interior is gained via at least the main proximal section and the auxiliary proximal section when in the first closed mode, and through at least the main proximal section, the auxiliary proximal section, and the auxiliary medial section when in the second open mode.
